(19) United States
(12) Patent Application Publication
(10) Pub. No.: US 2006/0107028 A1
(43) Pub. Date: May 18, 2006

(54) Loop control circuit for a data processor

(75) Inventors: Patrick Peter Elizabeth Meuwissen, Eindhoven (NL); Nur Engin, Eindhoven (NL); Cornelis Hermanus Van Berkel, Eindhoven (NL); Marco Jan Gerrit Bekooij, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,240

(22) PCT Filed: Oct. 31, 2003
(86) PCT No.: PCT/IB03/04962

§ 371 Date: May 24, 2005

(30) Foreign Application Priority Data
Nov. 28, 2002 (EP) 02079975.5

(51) Int. Cl. G06F 9/44

(52) U.S. Cl. 712/241

(57) ABSTRACT

A data processor (200) includes an operation execution unit (225) for executing instructions from an instruction memory (210) indicated by a program counter (220). A loop control circuit (230) stores respective associated loop information for a plurality of instruction loops in a register bank (232). The loop information includes at least an indication of an end of the loop and a loop count for indicating a number of times the loop should be executed. The loop control circuit (230) detects that one of the loops needs to be executed and in response to said detection, loads the loop information for the corresponding loop, and controls the program counter to execute the corresponding loop according to the loaded loop information. The loop information is initialized in response to a loop initialization instruction (240), where the initialization instruction is issued prior to and independent of a start of the loop initialized by the loop information.

### FIELD OF THE INVENTION

The invention relates to a loop control circuit for a data processor, to a data processor with a loop control circuit, and to a method of executing a loop in a data processor.

### BACKGROUND OF THE INVENTION

The performance of processors continuously increases. This brings functionality traditionally implemented using hardware in the reach of execution by processor under control of a suitable program. It also enables software-based signal processing of new functionality or existing functionality at increased quality. An example of new functionality is third generation wireless communication, such as based on the UMTS/FDD, TDD, IS2000, and TD-SCDMA standard. These systems operate at very high frequencies. Modems (transceivers) for 3G mobile communication standards such as UMTS require approximately 100 times more digital signal processing power than GSM. It is desired to implement a transceiver for such standards using a programmable architecture in order to be able to deal with different standards and to be able to flexibly adapt to new standards. Using conventional DSP technology operating at conventional frequencies could require as many as 30 DSPs to provide the necessary performance. It will be clear that such an approach is neither cost-effective nor power efficient compared to conventional hardware-based approaches of transceivers for single-standards. The digital signal processing capabilities of a processor can be increased by using pipelining.

U.S. Pat. No. 4,792,892 describes a pipelined processor. To execute a loop control instruction, that specifies repeated execution N times of a sequence of “T” instructions, the processor includes a loop circuit having an instruction counter which counts execution of the instructions in the loop sequence and produces an end-of-sequence signal upon each completion of the loop. A register is used that refreshes the program counter with the address of the first instruction in the loop in response to each end-of-sequence signal. A loop counter is used for counting the number of completions of the loop and delivers a signal indicating the end of the loop portion of the entire program and enables the program counter to continue on with the rest of the program. Pipelined calculations are critical, inter alia, the arguments and results have to be presented and read in accord with a narrow configuration. The disclosed pipelined processor allows a loop control instruction for initializing the loop to be executed a number “D” instructions before the start of the loop. The loop control circuit incorporates a counter to count the “D” instructions before triggering execution of the loop sequence “N” times. The known system provides more scheduling freedom for pipelined operation involving one loop.

A further way of improving the performance of a processor is to use a vector processor. A vector consists of more than one data element, for example sixteen 16-bit elements. A functional unit of the processor operates on all individual data elements of the vector in parallel, triggered by one instruction. The conventional vector processor architecture is ineffective for applications that are not highly vectorizable. For use in consumer electronics applications, in particular mobile communication, the additional costs of a vector processor can only be justified if a significant speed-up can be achieved.

### SUMMARY OF THE INVENTION

It is an object of the invention to provide a processor, loop control circuit and method of executing a loop that better supports high-performance processing.

To meet the object of the invention, a data processor for executing instructions stored in an instruction memory and which are specified by a program counter includes an operation execution unit for executing instructions indicated by the program counter; and a loop control circuit operative to store respective associated loop information for a plurality of instruction loops; the loop information for an instruction loop including at least an indication of an end of the loop and a loop count for indicating a number of times the loop should be executed; detect that one of the loops needs to be executed and in response to said detection, load the loop information for the corresponding loop, and control the program counter to execute the corresponding loop according to the loaded loop information; initialize the loop information in response to a loop initialization instruction, where the initialization instruction is issued prior to and independent of a start of the loop initialized by the loop information.

According to the invention, multiple loops can be initialized where the loop initialization is independent of the start of the loop. Of each loop at least a loop count and indication of an end of the loop (e.g. in the form of an address of the last instruction in the loop sequence or in the form of a number of instructions in the sequence, specifying an end of the sequence relative to a start address of the sequence) are stored. In the prior art system of U.S. Pat. No. 4,792,892 a loop is automatically started after “D” instructions have been executed since the loop initialization instruction. Such an approach is particularly difficult, if not impossible, for use with more than one loop, since it may not been known after how many instructions a second loop needs to be started. It should also be noted that a zero-overhead looping implementation is known from the R.E.A.L. DSP of Philips Electronics that allows multiple loops to be specified. This DSP allows pre-initialization of a loop by specifying the loop end address using a loop initialization instruction. The initiation (i.e. start) of the loop is coupled to the remaining part of the loop initialization where the loop counter is specified. Providing the loop counter automatically initiates the corresponding loop. This means that starting of a loop always requires one dedicated loop initialization/initiation instruction to be inserted into the instruction stream.

In a preferred embodiment as specified in the dependent claims 2, the loop control circuit is operative to execute a plurality of the instruction loops in a nested form, wherein an inner loop is initialized before starting execution of an immediately surrounding loop. This significantly reduces the overhead involved in initializing execution loops. Preferably, all the loop initialization is performed outside the outermost loop. In this case, no instruction cycles are devoted to loop initiation inside the nested loops. The inventors have realized that in particular digital signal processing involves frequent execution of usually short loops. Loop nesting of 2 or 3 levels deep occurs regularly. For example, for processing an image the outermost loop may involve processing of an image frame or field, where the next level loop involves processing of the blocks of pixels in the frame/field and the third level may involve processing of the pixels within the block. Traditionally, the loop initialization is at the same nesting level preceding the start of the loop. In a program with three nesting levels where each loop is executed 10 times (and consequently the innermost loop is executed 1000 times), the outermost loop is initialized once, the second loop is initialized 10 times and the inner loop is initialized 100 times. In the system according to the invention, all loops may be initialized at the highest level, before starting execution of the first loop. This implies that only three loop initializations are required instead of 111 times in the known systems. This also makes the loop circuit highly suitable for vector processors. Whereas it may be possible to vectorize instructions within a loop, initialization of a loop is difficult to vectorize. Using the approach according to the invention, the number of non-vectorized instructions in a typical program can be reduced.

In itself various ways may be used to determine/indicate a start of a loop. As described in the dependent claim 3, each instruction for the operation execution unit includes a loop start field enabling to indicate that the instruction is a first instruction of a sequence of instructions forming an instruction loop to be executed by the operation execution unit. For example, one bit may be added to the regular instructions (typically those that can occur in an instruction loop) to indicate whether or not this instruction is the start of a loop. In this way, no indication of a start location and/or time of a loop needs to be provided. It will be appreciated that this comes at the expense of using at least one additional bit in the instruction. This increase of instruction size can be reduced by using instruction compression.

According to the measure as described in the dependent claim 4, the loop control circuit is operative, in response to detecting that the loop start field indicates a start of an instruction loop, to store an indication of a start address of the loop in the loop information associated with the loop. For example, the loop control circuit may retrieve the address of the current instruction from the program counter and store it in a register. Each time the end of the loop is received (as indicated by the end information stored for the loop), the start address can be retrieved from the register. If so desired, the start address may also be stored in the form of an offset relative to the end of the loop (as indicated in the loop information), for example by indicating the number of instructions in the loop.

According to the measure as described in the dependent claim 5, the loop information is stored according to a sequential nesting level of the loop, where for a respective one of the nesting levels at most one loop can be specified at each moment in time; the loop control circuit being operative to store a current nesting level of instructions being executed; and update the nesting level in response to detecting a start of a loop by checking the loop start field; and detecting an end of a loop by comparing the program counter to the indication of the end of the loop stored for the loop. Using only a one-bit loop start indicator nested loops can be started, where at each nesting level there can at most be only one loop. An indication in the start field then implicitly indicates which loop is to be started (i.e. the loop at the next deeper level). Similarly, exiting a loop implies that control is returned to a next higher level (at the highest level, no loop is being executed, but normal sequential processing (which may be pipelined and/or vectorized) takes place. Assuming that a deeper loop is represented by a higher number, entering a loop results in incrementing the nesting level (or, similarly, the loop number) and exiting the loop results in decrementing the nesting level.

To overcome the limitation of only being able to initialize one loop at each nesting level, the measure of the dependent claim 6 describes that the loop start field enables to indicate which one of a plurality of specifiable loops needs to be started. For example, each loop may be associated with a unique sequential number where the start field can include such a number. If the maximum number of loop nesting levels is MAX, a total of ┌²log(X)┘ bit needs to be added to the applicable instructions.

According to the measure as described in the dependent claim 7, the loop information also includes an indication of a begin of the loop. In principle, the indication may take any suitable form, such as an absolute memory address or a relative memory address within an addressable range of a memory page or relative to a known position. In particular, if either the loop start address or loop end address is specified in one of those ways, the other address can be specified as an offset relative to the specified address. Such an offset represents the number of instructions in the loop.

According to the measure as described in the dependent claim 8, the loop control circuit is operative to detect a start of a loop by comparing the program counter to the indication of a begin of a loop stored in the loop information. In a situation where there is no time or position relationship between the loop initialization instruction and the start of the initialized loop, comparing the current address (as present in or derivable from the program counter) with the start addresses of the loops as stored in the loop information. This comparison may take place by comparing the program counter to each stored loop start address until a match is found or all loop start addressees have been compared. This process may be optimized, for example by sorting start addresses, simplifying and/or speeding the comparison process.

According to the measure as described in the dependent claim 9, the loop initialization instruction includes a plurality of fields for initializing loop information of a plurality of loops in one operation. Particularly if a wide memory is used, such as a memory for storing VLIW instructions, several loops can be initialized using only one instruction. This reduces the overhead in loop initialization even further.

To meet the object of the invention, a loop control circuit for use in a processor with an operation execution unit for executing instructions indicated by a program counter is operative to store respective associated loop information for a plurality of instruction loops; the loop information for an instruction loop including at least an indication of an end of the loop and a loop count for indicating a number of times the loop should be executed; detect that one of the loops needs to be executed and in response to said detection, load the loop information for the corresponding loop, and control the program counter to execute the corresponding loop according to the loaded loop information; initialize the loop information in response to a loop initialization instruction, where the initialization instruction is issued prior to and independent of a start of the loop initialized by the loop information.

To meet the object of the invention, a method of causing a processor to execute instruction loops specified by a program counter includes storing respective associated loop information for a plurality of instruction loops prior to and independent of a start of the loop; the loop information for an instruction loop including at least an indication of an end of the loop and a loop count; and detecting that one of the loops needs to be executed and in response to said detection, loading the information for the corresponding loop, and controlling the program counter to execute the corresponding loop according to the loaded loop information.

These and other aspects of the invention are apparent from and will be elucidated with reference to the embodiments described hereinafter.

### BRIEF DESCRIPTION OF THE DRAWINGS

In the drawings:

FIG. 1 shows an exemplary program using the loop initialization according to the invention;

FIG. 2 shows a block diagram of the processor and circuit according to the invention;

FIG. 3 shows an embodiment of the processor and circuit according to the invention;

FIG. 4 shows a counter suitable for use by the loop control circuit; and

FIG. 5 shows a preferred processor in which the loop control circuit is used.

### DETAILED DESCRIPTION OF THE PREFERRED EMBODIMENT

The loop control circuit according to the invention is particularly suitable for, but not limited to, use in digital signal processors (DSPs). For digital signal processing applications frequently loops and nested loops occur with relatively few instructions in a loop and usually uninterrupted processing of a loop. Such system can benefit from the architecture according to the invention that reduces the number of times a loop initialization instruction needs to be executed. The loop control circuit is also particularly suitable for pipelined processors since it allows free scheduling of the loop initialization instructions (as long as a loop is initialized before the start of the loop). As such, the instruction(s) immediately preceding the start of a loop may be used for any purpose as, for example, is best for maintaining a high filling degree of the pipeline.

The loop circuit can also advantageously be used in a vector processor. The vector processor can be used for regular, “heavy/duty” processing, in particular the processing of inner-loops. As such, it can provide large-scale parallelism for the vectorizable part of the code to be executed. However, fully exploiting this parallelism is not always feasible, as many algorithms do not exhibit sufficient data parallelism of the right form. The so-called “Amdahl's Law” states that the overall speedup obtained from vectorization on a vector processor with P processing elements, as a function of the fraction of code that can be vectorized (f), equals (1−f+f/P)⁻¹. This means that when 50% of the code can be vectorized, an overall speedup of less than 2 is realized (instead of the theoretical maximum speedup of 32). This is because the remaining 50% of the code cannot be vectorized, and thus no speedup is achieved for this part of the code. Even if 90% of the code can be vectorized, the speedup is still less than a factor of 8. After vectorization of the directly vectorizable part of the code, most time is spent on the remaining code. The remaining code can be split into four categories:

address related instructions (e.g. incrementing a pointer into a circular buffer, using modulo addressing)

regular scalar operations (i.e. scalar operation that correspond to the main loop of the vector processor)

looping

irregular scalar operations

The loop control circuit reduces the time spent on looping and as such contributes to making vector processing more suitable for consumer electronic applications, in particular mobile communication, the additional costs of a vector processor can only be justified if a significant speed-up can be achieved.

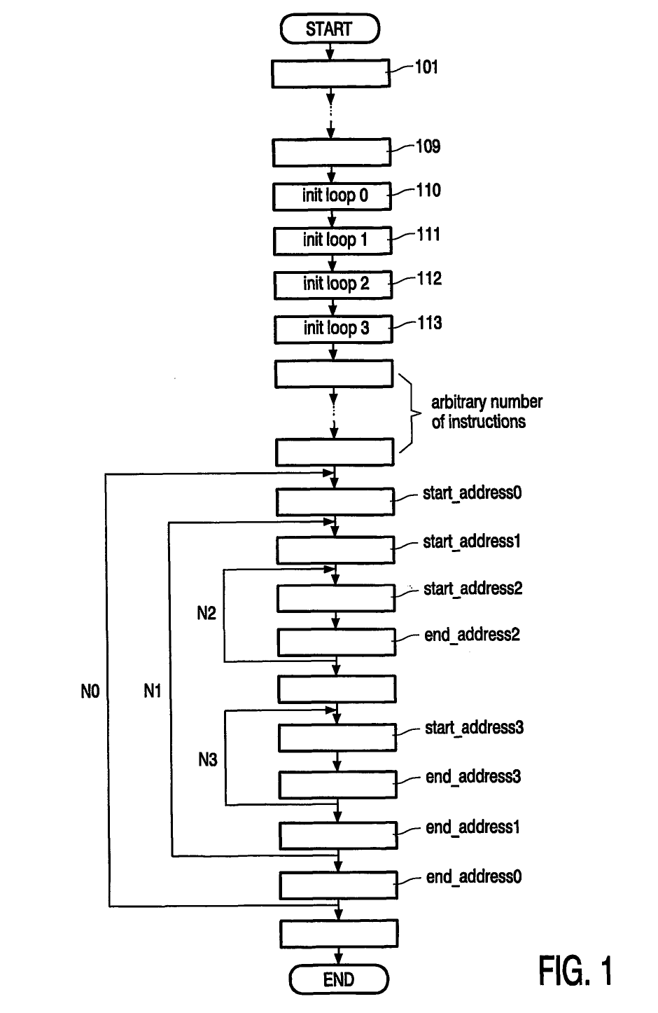

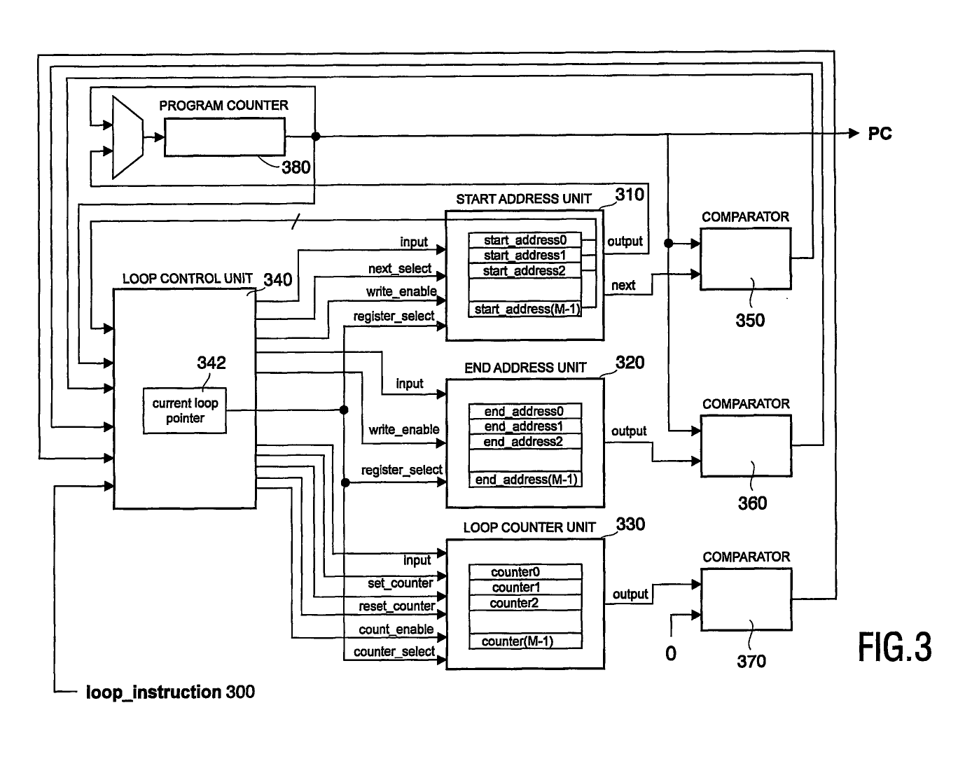

FIG. 1 shows an exemplary program using the loop initialization according to the invention. The exemplary program includes four loops, shown as N1 to N4, organized in three nesting levels. Loop N0 is the highest level. N2 is one level deeper and N3 and N4 are two successive loops at one level deeper. The program starts with an arbitrary number of instructions, indicated as 101 to 109. This is followed by initialization of all four loops, show as 110 to 113. According to the invention, the loop initialization can be performed at any arbitrary point in the program, provided that it is before the starting address (in the figure: start_address) of the corresponding loop. As such there is also no strict reason for initializing a higher level loop before initializing a inner loop. In the initialization step, at least the loop count, and an indication of the end of the loop (hereinafter referred to as loop end address) are specified. Depending on the implementation also an indication of the beginning of the loop may be specified, hereinafter referred to as the loop start address. These three parameters fully specify each loop, so that when the start address is reached during program execution the loop can be started automatically without requiring any initiation instruction, i.e. a separate instruction to trigger the start of an execution of a loop. A detailed embodiment capable of doing so will be described with reference to FIG. 3. As can be seen FIG. 1, this principle can be applied to nested loops, and works also for cases where more than one loop is present at one nesting level. If no loop start address is given (either explicit or implicit) in the initialization instruction, the trigger to start the loop can be incorporated in the first instruction of the loop, as will be described in more detail below.

In the example given in FIG. 1, all the initialization is performed outside the outermost loop N0. Since no instruction cycles are devoted to loop initiation inside the nested loops, the loop overhead is substantially reduced. It is also possible to perform some of the initialization for the inner loops inside the outer loops, but this reduces the advantages of this invention. For nested loops, an advantage is achieved if at least one inner loop is initialized before starting execution of an immediately surrounding loop. As indicated, preferably all loops are initialized at the main execution level outside any loop.

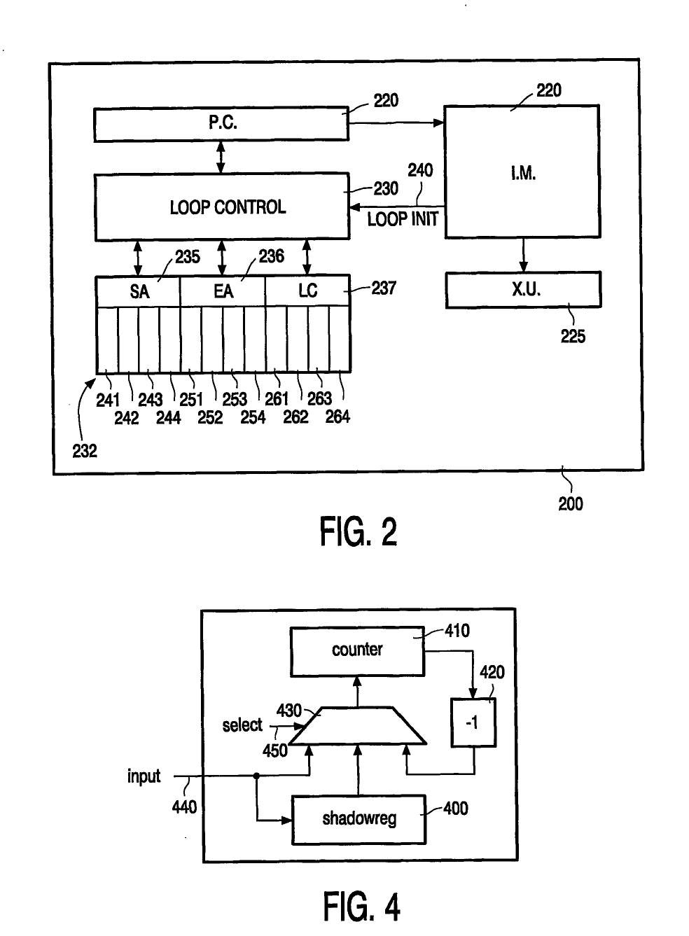

FIG. 2 shows a basic block diagram of the data processor 200 according to the invention. The data processor 200 is capable of executing instructions stored in an instruction memory 210. The instruction to be executed is specified by a program counter 220. The instruction memory may entirely or partly (e.g. in the form of an instruction cache) be incorporated in the processor. If so desired, the instruction memory may also be separate from the processor. The processor includes an operation execution unit 225 for executing the normal instructions indicated by the program counter. Special instructions, like processor configuration instructions may be dealt with separately. This is not part of the invention and will not be described further. A loop control circuit 230 is capable of storing respective associated loop information for a plurality of instruction loops. The loop information for an instruction loop including at least an indication of an end of the loop and a loop count for indicating a number of times the loop should be executed. The loop information may also include an indication of a start of the loop. The actual storage 232 (e.g. in the form of one or more register units) may be in the loop control unit 230 or connected to it. FIG. 2 shows an exemplary way of arranging the storage 232. The storage is divided in three register banks 235, 236 and 237, for storing start addresses, end addresses, and loop counts, respectively. In the figure, each bank can store four values. Shown are 241, 242, 243, and 244 for the start addresses, 251, 252, 253, and 254 for the end addresses, and 261, 262, 263, and 264 for the loop counts. As such, in this example a maximum of four loops can be initialized at each moment in time. The loop control unit is able to identify the values for one loop (for example for initialization of the values and for use of the value for executing a loop). The values of one loop of the respective loops may, for example, be indicated by a loop number. For example, loop no. 0 includes the values 241, 251, and 261; loop no. 2 includes the values 242, 252, 262, etc. The loop control circuit is able to detect that one of the loops needs to be executed. Below, several ways of detecting this will be described in more detail. In response to detecting that a loop needs to be started, the loop control circuit is able to load the loop information for the corresponding loop, and control the program counter to execute the corresponding loop according to the loaded loop information. In this respect, the loop control circuit acts the same as known loop control circuits and this aspect will not be described in more detail. According to the invention, the operation control unit 230 is able to initialize the loop information in response to a loop initialization instruction, shown as 240. The loop control unit ensures that the supplied information is stored in the appropriate storage location of the storage 232 for use at a later moment. The initialization instruction must be issued prior to and is independent of a start of the loop initialized by the loop information. The loop initialization instruction may be loaded from the instruction memory 210 under control of the program counter 220. An instruction decode unit (not shown) may supply the information in the instruction to the loop control unit instead of providing the instruction to the execution unit 230.

To further illustrate the invention, the instruction sequence for a conventional zero-overhead loop processor, such as the Philips R.E.A.L DSP, is shown in the left column of the following table (table 1), whereas the instruction sequence according to the invention is shown in the right column:

TABLE 1

| | |
|---|---|
| loop 1 init | loop 1 init |
| loop 1 body { | loop 2 init |

| | |
|---|---|
| instr 1-1 | loop 3 init |
| : | loop 1 body { |

| | |
|---|---|
| loop 2 init | instr 1-1 |
| loop 2 body { | : |

| | |
|---|---|
| inst 2-1 | loop 2 body { |

| | |
|---|---|
| : | inst 2-1 |
| loop 3 init | : |
| loop 3 body { | loop 3 body { |
| inst 3-1 | inst 3-1 |
| : | : |
| } | } |
| : | : |

| | |
|---|---|
| } | } |
| : | : |

| | |
|---|---|
| } | } |

As indicated above, the loop initialization instruction provides at least the loop count, and a loop end address. For the loop control circuit to determine that a loop should be started, each instruction for the operation execution unit includes a loop start field enabling to indicate that the instruction is a first instruction of a sequence of instructions forming an instruction loop to be executed by the operation execution unit. In practice all instructions may have such a loop start field to maintain a consistent instruction structure for all instructions. However, it will be appreciated that this is not required. For example, certain instructions may only be used for configuring a processor and not be suitable for use within a loop. In principle, such instructions do not need the field. In a simple form, the loop start field may be a one-bit field in the instruction. A pre-determine value (e.g. binary ‘1’) may be used to indicate that the instruction is a first instruction of a loop, whereas the other binary value (e.g. ‘0’) is used for all instructions in the sequence that are not the first instruction of the loop. In the next table to the left for each instruction an exemplary start field value is indicated.

TABLE 2

| | |
|---|---|
| 0 | loop 1 init |
| 0 | loop 2 init |
| 0 | loop 3 init |
| | loop 1 body { |

| | |
|---|---|
| 1 | instr 1-1 |
| 0 | : |
| | loop 2 body { |

| | |
|---|---|
| 1 | inst 2-1 |
| 0 | : |
| | loop 3 body { |
| 1 | inst 3-1 |
| 0 | : |
| | } |
| 0 | : |

| | |
|---|---|
| | } |
| 0 | : |
| } | |

It will be appreciated that also other encodings of the field are possible as long as the loop control circuit can determine that an instruction is a first instruction in a loop. Preferably, in response to detecting that the loop start field indicates a start of an instruction loop, the loop control circuit 230 stores an indication of a start address of the loop in the loop information 232 associated with the loop. In itself any suitable indication may be stored, for example using a full absolute address, using a relative address within an addressable range (so relative to the beginning of the range), or using an address relative to the end address of the loop (e.g. using a count of the number of instructions in the loop).

Using only a one-bit start field it is possible to support multiple nested loops, as was illustrated in table 2. A limitation is that only one loop can be specified at each nesting level of the loop. Referring to FIG. 1 it would not be possible to have two successive loops N2 and N3 at the same nesting level, since the one-bit indicator can not distinguish between the two loops at the same level. With this limitation, it is additionally required that the loop control circuit know the nesting level of a loop. This can be achieved in a simple way, for example, by letting the loop number represent the nesting level (a sequentially higher loop number indicates a deeper loop). The loop control circuit stores a current loop no./nesting level of instructions being executed, for example in a register. Assuming the indicated sequential ordering of loops/nesting levels, the loop control circuit increments the current loop no./nesting level in response to detecting a start of a loop. As described above, it may detect the start of a loop by checking the loop start field of the instruction to be executed next by the processor. In response to detecting an exit of the loop, the loop control circuit decrements the current loop no./nesting level. The loop control circuit can detect an end of a loop by comparing the program counter to the stored end address of the current loop indication. An exit of a loop occurs if the end of the loop is detected and the loop has been executed according to the stored loop count.

In a further embodiment according to the invention, the loop start field enables to indicate which one of a plurality of specifiable loops needs to be started. For example, by specifying a loop number in each instruction the loop control circuit can, by determining a change in loop number between two successive instructions, that a new loop is entered or exited. The main execution level (not part of any loop) may for example be indicated using level 0 (zero). All other loops may be numbered in the sequence they appear in the program, but this is not required; any sequence is in principle allowed. For a program with three loops a distinction between the three loops and the main level must be made, this requires two bits. In table 3 to the left for each instruction an exemplary 2-bit start field value is indicated. The left column shows the working for three nested levels, whereas the right column shows it for two nesting levels, with two successive loops at level 2.

TABLE 3

| 00 loop 1 init | | 00 loop 1 init | |
|---|---|---|---|
| 00 loop 2 init | | 00 loop 2 init | |
| 00 loop 3 init | | 00 loop 3 init | |
| loop 1 body { | | loop 1 body { | |
| 01 | instr 1-1 | 01 | instr 1-1 |
| 01 | : | 01 | : |
| 10 | loop 2 body { | 10 | loop 2 body { |

| | | | |
|---|---|---|---|
| 10 | inst 2-1 | 10 | inst 2-1 |
| 10 | : | 10 | : |
| 11 | loop 3 body { | 10 | : |

| | | | |
|---|---|---|---|
| 11 | inst 3-1 | | } |
| 11 | : | 11 | loop 3 body { |
| | } | 11 | inst 3-1 |
| 10 | : | 11 | : |

| | | | |
|---|---|---|---|
| | } | | } |
| 01 | : | 01 | : |

| | |
|---|---|
| } | } |

FIG. 3 shows a block diagram for a preferred embodiment of the zero-overhead loop (0 OHL) unit inside the program controller according to the principles explained with reference to FIG. 1. The only primary input of the 0 OHL unit is the loop instruction 300. This instruction consists of the loop-related part of the complete instruction flow, and when no loop instruction is present the signal loop_instruction equals to no-operation (NOP). When a loop initialization instruction is issued, the input signal loop_instruction specifies loop count, start address and end address. The preferred zero-overhead loop hardware includes two address register units (in the figure: START ADDRESS UNIT 310 and END ADDRESS UNIT 320), a loop counter unit 330, a loop control unit 340, and three comparator units 350, 360, and 370. The hardware supports M loops, i.e. the maximum nesting level is M when each nesting level contains only one loop. Consequently, the start and end address units 310, 320 have M registers for storing the loop start and end addresses for each loop. Also, M loop counters are included in the loop counter unit 330. When a loop initialization occurs, the loop parameters (start address, end address and loop count) are written into the matching registers. The loop instruction contains an indication of the loop being initialized, preferably in a form directly convertible to the register_select signal (and counter_select signal for the loop counter unit). The loop control unit 340 uses this information to select the matching register via the register_select signals and counter_select signal. The respective register values and counter value are provided via the respective input signals. The respective write_enable signals and set_counter signal are used for controlling the writing of the register/counter value to the indicated register/counter field.

The current loop is defined as the most recent loop the program has entered. The loop control unit 340 uses the current loop pointer 342 for generating the signal register_select, which selects the loop parameters for the current loop. The respective comparators 310 and 320 at the output of the start and end address units are responsible for comparing the program counter 380 value to the values already stored in these units. The comparator may compare all M register values of its register unit to the current value of the program counter in parallel. If it detects a matching value, the comparator indicates equality. When more than one start address value matches to the program counter, the current loop is determined by taking the loop corresponding to the smallest end address as the current loop. When more than one end address value matches the program counter, the loops are treated in an order starting from the current loop. In a preferred embodiment, the loop control unit 340 also performs ordering of start addresses and generates a signal (in the figure: next_select) for selecting the next start address (in the figure: the output ‘next’ of start address unit) expected after the present program counter value. Correspondingly, when two or more loops start at the same address, the loop with the smallest end address is automatically selected by the signal next_select. In this way, multiple loops starting at the same address can also be treated without extra overhead.

At any point in the program (also when the program counter corresponds to an address outside the outermost loop) one start address (in the figure: next) is selected and compared to the program counter value. Additionally, when the program counter is inside at least one loop, the program counter is compared to one end address (in the figure: output of the END ADDRESS UNIT) corresponding to the configuration of the current loop. When an equality is detected at the start address comparator 310, the loop control unit 340 updates the current loop pointer 342, the current loop being specified by the new start address, the end address residing in the corresponding end address register, and the iteration count residing in the shadow register of the corresponding counter.

When an equality is detected at the end address comparator 320, the loop control unit 330 enables the corresponding loop counter (in the figure: count_enable). The loop counter which is already selected by means of the signal count_select is then decremented and compared to 0. If the counter value is 0, the loop control unit updates the current loop pointer (the program goes out of the current loop), the program counter is incremented and the program execution continues as described above with the new value of the current loop. At this point, if the outermost loop corresponding to the loop which has just exited still has more iterations to go, the loop counter value must be reinitialized to the original value so that the loop can be started again during the next iteration of the outer loop. For this reason, a check must be included in the loop control unit for determining whether this is the case. If the check is positive (i.e. the corresponding outermost loop is still active), the loop control unit generates a reset_counter signal which (re-)copies from a shadow register in to the loop register the original number of loop iterations of the loop. Such a use of a shadow register is known from U.S. Pat. No. 6,064,712 FIG. 4 illustrates a loop counter circuit with a shadow register 400. The value stored in the counter 410 can be decremented by block 420. A multiplexer can be controlled to load into the counter 410 either the decremented value, the value stored in the shadow register or an input value 440. The signal select 450 is generated using signals set_counter, reset_counter and count_enable (shown in FIG. 2), and used to control the multiplexer. When a loop configuration instruction is received (set_counter), the number of iterations specified for the new loop configuration can be loaded via the input value 440. The other two options are updating the loop from the shadow register (reset_counter) and decrementing the loop counter (count_enable), as seen in FIG. 2. If equality is detected with the end address but the decremented count value is not zero, the start address of the corresponding loop (selected by the register_select input of the START ADDRESS UNIT 310) is copied into the program counter 380 causing the loop to be repeated.

The loop control circuit is preferably used in a processor optimized for signal processing. Such a processor may be a DSP or any other suitable processor/micro-controller. The remainder of the description describes using the circuit in a highly powerful scalar/vector processor. The scalar/vector processor is mainly used for regular, “heavy/duty” processing, in particular the processing of inner-loops. The vast majority of all signal processing will be executed by the vector section of the scalar/vector processor. The operation of the regular scalar operations can be optimized by tightly integrating scalar and vector processing in one processor. A separate micro-controller or DSP 130 may be used to perform the irregular tasks and, preferably, controls the scalar/vector processor as well.

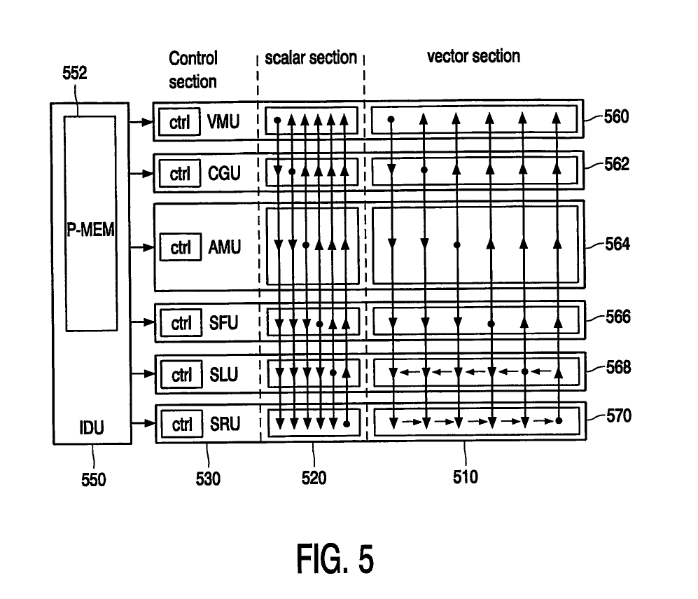

FIG. 5 shows the main structure of the processor in which the loop control circuit according to the invention may be used. The processor includes a pipelined vector processing section 510. To support the operation of the vector section, the scalar/vector processor includes a scalar processing section 520 arranged to operate in parallel to the vector section. Preferably, the scalar processing section is also pipelined. To support the operation of the vector section, at least one functional unit of the vector section also provides the functionality of the corresponding part of the scalar section. For example, the vector section of a shift functional unit may functionally shift a vector, where a scalar component is supplied by (or delivered to) the scalar section of the shift functional unit. As such, the shift functional unit covers both the vector and the scalar section. Therefore, at least some functional units not only have a vector section but also a scalar section, where the vector section and scalar section can co-operate by exchanging scalar data. The vector section of a functional unit provides the raw processing power, where the corresponding scalar section (i.e. the scalar section of the same functional unit) supports the operation of the vector section by supplying and/or consuming scalar data. The vector data for the vector sections are supplied via a vector pipeline.

In the preferred embodiment of FIG. 5, the scalar/vector processor includes the following seven specialized functional units.

Instruction Distribution Unit (idu 550). The idu contains the program memory 552, reads successive vliw instructions and distributes the 7 segments of each instruction to the 7 functional units. Preferably, it contains the loop unit that supports zero-overhead looping according to the invention.

Vector Memory Unit (vmu 560). The vmu contains the vector memory (not shown in FIG. 5).

The Code-Generation Unit (cgu 562). The cgu is specialized in finite-field arithmetic, for example for generating vectors of cdma code chips as well as related functions, such as channel coding and CRC.

ALU-MAC Unit (amu 564). The amu is specialized in regular integer and fixed-point arithmetic.

ShuFfle Unit (sfu 566). The sfu can rearrange elements of a vector according to a specified shuffle pattern.

Shift-Left Unit (slu 568). The slu can shift the elements of the vector by a unit, such as a word, a double word or a quad word to the left. The produced scalar is offered to its scalar section.

Shift-Right Unit (sru 570). The sru is similar to the slu, but shifts to the right. In addition it has the capability to merge consecutive results from intra-vector operations on the amu.

As indicated above, many different ways may be used to indicate a start and end of a loop. In a preferred embodiment, a start address and end address may be specified using respective 16-bit addresses. The loop counter maybe specified also using 16 bits. Consequently, 48 bits are required for specifying parameters of a loop initialization instruction. Assuming that a maximum of three loops can be specified, a further two bits are required for indicating the loop, giving a total of 50 bits. Additionally, bits are required for identifying the loop initialization instruction among the possible instructions. If the instruction width allows, advantageously the loop initialization instruction includes a plurality of fields for initializing loop information of a plurality of loops in one operation. Particularly if the loop control circuit is used in a VLIW (Very Large Instruction Word) processor, such as for example shown in FIG. 5, more than one loop can be configured in one instruction. For the VLIW processor of FIG. 5, preferably 128 bit wide instructions are used. The instruction may be structured such that one bit is used to distinguish between a regular VLIW instruction (to be executed by the execution units) and an IDU instruction. An IDU instruction may use two bits to distinguish between four IDU instructions (being call, return, loop, or end-of-program). Using, as described above, an instruction memory with an address width of 16 bit, an 11-bit loop counters, 2 bits for identifying a loop, it is possible to configure two loops in one instruction. The fields of the instruction can then be as indicated in table 4. The second column indicates the field width.

TABLE 4

| | | |
|---|---|---|
| <IDU instruction, VLIW instruction> | 1 | bit |
| <IDU command> | 2 | bits |
| <loop number1> | 2 | bits |
| <loop count 1> | 16 | bits |
| <start_address1> | 16 | bits |
| <end_address1> | 16 | bits |
| <loop number2> | 2 | bits |
| <loop count 2> | 16 | bits |
| <start_address2> | 16 | bits |
| <end_address2> | 16 | bits |

It will be appreciated that the various ways shown for initializing a loop may be used in combination with techniques for compacting code (e.g. by compressing instructions). To clarify the principles of the invention to such compaction has been shown.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in a claim.

1. A data processor for executing instructions stored in an instruction memory and which are specified by a program counter; the processor including:
an operation execution unit for executing instructions indicated by the program counter; and
a loop control circuit operative to:
store respective associated loop information for a plurality of instruction loops; the loop information for an instruction loop including at least an indication of an end of the loop and a loop count for indicating a number of times the loop should be executed;
detect that one of the loops needs to be executed and in response to said detection, load the loop information for the corresponding loop, and control the program counter to execute the corresponding loop according to the loaded loop information;
initialize the loop information in response to a loop initialization instruction, where the initialization instruction is issued prior to and independent of a start of the loop initialized by the loop information.

2. A data processor as claimed in claim 1, wherein the loop control circuit is operative to execute a plurality of the instruction loops in a nested form, wherein an inner loop is initialized before starting execution of an immediately surrounding loop.

3. A data processor as claimed in claim 1, wherein each instruction for the operation execution unit includes a loop start field enabling to indicate that the instruction is a first instruction of a sequence of instructions forming an instruction loop to be executed by the operation execution unit.

4. A data processor as claimed in claim 3, wherein the loop control circuit is operative, in response to detecting that the loop start field indicates a start of an instruction loop, to store an indication of a start address of the loop in the loop information associated with the loop.

5. A data processor as claimed in claim 2, wherein the loop information is stored according to a sequential nesting level of the loop, where for a respective one of the nesting levels at most one loop can be specified at each moment in time; the loop control circuit being operative to store a current nesting level of instructions being executed; and update the nesting level in response to:
detecting a start of a loop by checking the loop start field; and
detecting an end of a loop by comparing the program counter to the indication of the end of the loop stored for the loop.

6. A data processor as claimed in claim 3, wherein the loop start field enables to indicate which one of a plurality of specifiable loops needs to be started.

7. A data processor as claimed in claim 1, wherein the loop information includes an indication of a beginning of the loop.

8. A data processor as claimed in claim 7, wherein the loop control circuit is operative to detect a start of a loop by comparing the program counter to the indication of a beginning of a loop stored in the loop information.

9. A data processor as claimed in any claim 1, wherein the loop initialization instruction includes a plurality of fields for initializing loop information of a plurality of loops in one operation.

10. A loop control circuit as claimed in claim 1.

11. A method of causing a processor to execute instruction loops specified by a program counter; the method including:
storing respective associated loop information for a plurality of instruction loops prior to and independent of a start of the loop; the loop information for an instruction loop including at least an indication of an end of the loop and a loop count; and
detecting that one of the loops needs to be executed and in response to said detection, loading the information for the corresponding loop, and controlling the program counter to execute the corresponding loop according to the loaded loop information.

12. A method as claimed in claim 11, wherein a plurality of the instruction loops can be executed in a nested form, and the method includes storing loop information for an inner loop prior to starting execution of an immediately surrounding loop.

13. A computer program product operative to cause a processor to perform the steps of claim 11.
